(19) United States
(12) Patent Application Publication
(10) Pub. No.: US 2010/0217462 A1
(43) Pub. Date: Aug. 26, 2010

(54) OPERATING SYSTEM AND METHOD FOR CONTROLLING A POWERED VEHICLE

(76) Inventors: Glenn Robert Shaffer, Erie, PA (US); Ajith Kuttannair Kumar, Erie, PA (US); Brian D. Lawry, Erie, PA (US); Mark Alan Linebach, McKean, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/390,654

(22) Filed: Feb. 23, 2009

(51) Int. Cl. G05D 1/00

(52) U.S. Cl. 701/19

(57) ABSTRACT

A system for the communication of data used in the operation of a powered vehicle comprises a plurality of controllers onboard the powered vehicle for controlling operations of the vehicle. At least one of the controllers has a memory in which data is stored and the data is accessible and used by at least two of the controllers for controlling vehicle operations. A communication link is provided between the at least two controllers for sharing data stored in the memory of one of the controllers to control operations of the powered vehicle.

### BACKGROUND OF THE INVENTION

Embodiments of the invention pertain to onboard controllers that control operations of powered vehicles and access databases that contain data relating to roadway, waterway, off-road, track, and other designated pathway systems that are used for transportation by powered vehicles. More specifically, embodiments of the invention relate to controllers on locomotives that access databases having stored information concerning railroad track systems.

Railroad companies operate trains and control railroad traffic on track systems that may include thousands of miles of railroad tracks. In order to control movement of trains on a track system, a track database is maintained that contains information relating to track topography, which is also referred to as the track profile data. The data stored in these databases includes among other things track grade data, track curvature data, and geographical coordinates or other data relative to the location of various points or segments of interest along the track, such as the location of wayside devices, changes in track grade, grade crossings, mile markers, signal locations, etc. In addition, the track database may include data relative to one or more civil speed limits associated with various track sections. Sometimes the track database may have temporary speed restrictions that may be imposed as a result for example, of track repairs taking place on the track.

In use, the track database for a selected track or sections of track on which a train will be traveling is provided to an operator, who prepares a trip plan based on the information provided in the track database and information provided in a train manifest. A hard copy of the track database and train manifest is provided, which takes several hours to print. Indeed, a hard copy of the track database and the train manifest may include several hundred pages, in part because the train manifest may provide information concerning all the railcars of a train that may be up to two miles long. Besides the length of time required to create such a document, the document itself is cumbersome to handle and carry on board the locomotive. The train operator uses the track database and manifest printout to verify that the locomotive's onboard operating system includes track profile data and train manifest information upon which the train operator shall rely to develop a trip plan. However, the operator does not verify data entries. Instead, the operator simply performs a high level verification to determine if the operating system has track data for those tracks or sections of the track system the train will be traveling on.

The operator, based on past experience and/or operating manuals, maps out a train route over the track sections provided. The route will include the identity of the different tracks the train will travel on, the different speeds at which the train will travel along the track, and/or the different dynamic braking operations that may be needed during the trip. Given the track grade, and other parameters such as train weight and length, the operator is able to determine the locomotive throttle positions and braking commands necessary to achieve the different desired speeds on the track, and plans the trip accordingly.

However, at times the data found in these databases is not complete, has not been updated, or is simply incorrect or inaccurate. In addition, locomotives include onboard operating systems that may comprise one or more controllers that provide for the automated control of certain locomotive functions. Such systems may include fuel savings systems, positive train control systems, brake control systems, and operator coaching systems, which use elements of the track database for the automated control of locomotive operations. The manufacturers or vendors of such systems provide relevant components of the track database; however, data conversion, human error, or other factors may lead to incorrect or inaccurate data entry. Therefore, the locomotive may have different controllers using the same components of the track database; however, the data for each controller is different, inconsistent, or otherwise not compatible. In instances in which the track profile data is not correct, or the controllers of the onboard operating system are using inconsistent data, the train is not operating at optimal efficiency. In a worst case scenario the use of incorrect or inaccurate data may result in an accident or train derailment.

### BRIEF DESCRIPTION OF THE INVENTION

An operating system, onboard a powered vehicle for controlling multiple operations of the powered vehicle, comprises a plurality of controllers onboard the powered vehicle for controlling operations of the vehicle. At least one of the controllers has a memory in which data is stored and the data is accessible and used by one or more of the other controllers for controlling vehicle operations. A communication link is provided between the controllers for sharing data stored in the memory of one of the controllers to control operations of the powered vehicle.

A method for controlling multiple operations of a powered vehicle comprises providing a plurality of controllers onboard the powered vehicle for controlling operations of the vehicle. At least one of the controllers has a memory in which data is stored and the data is accessible and used by one or more of the other controllers for controlling vehicle operations. There is also a step for transmitting signals indicative of the requested data in the memory from one controller to another controller to control operations of the powered vehicle.

In an embodiment, data associated with a train manifest and track profile is stored in an off-board station server or data storage device. An operator, on-board the vehicle, or from a remote location relative to the server, enters his/her verification code and a vehicle identifier to view and verify that the train manifest and track profile data for the associated has been updated. Then the data is transmitted from the server to an onboard operating system.

In another embodiment there is an operating system, onboard a powered vehicle, for controlling multiple operations of the powered vehicle. The operating system comprises a plurality of controllers onboard the powered vehicle for controlling multiple operations of the vehicle; a non-distributed memory in which data is stored, said data relating to operations and control of the powered vehicle; and a communication link between the controllers and the memory for the controllers to obtain the data from the memory and store the data in the memory. The non-distributed memory is the sole data storage in the powered system for long term storage of said data for the plurality of controllers.

In an operating system, onboard a locomotive, for controlling multiple operations of the locomotive, the operating system comprises a first controller for controlling a positive train control system of the locomotive; a second controller for controlling an operator coaching and/or operator interface system of the locomotive; a third controller for controlling a trip optimizer and/or fuel savings system of the locomotive; a memory in which locomotive operations data is stored for each of the positive train control system, the operator coaching and/or operator interface system, and the trip optimizer and/or fuel savings system. A communication link between the controllers and the memory for the controllers obtains the operations data from the memory and stores the operations data in the memory. In such an embodiment of an operating system, the memory may be a non-distributed memory; and, the non-distributed memory is the sole data storage in the locomotive for long term storage of said operations data for the plurality of controllers and the positive train control system, the operator coaching and/or operator interface system, and the trip optimizer and/or fuel savings system.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 is a schematic illustration of an onboard operating system incorporating an embodiment of the invention.

FIG. 2 is a schematic illustration of an onboard operating system incorporating a second embodiment of the invention.

FIG. 3 is a flow chart providing steps in an embodiment of the invention.

### DETAILED DESCRIPTION OF THE INVENTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained. While the invention is described below in reference to locomotives and trains movement on a railroad track the invention is not so limited. The invention may be used with other vehicles including marine vessels, off-highway vehicles, on-road vehicles, etc. The term “powered vehicle” as used herein shall comprise the vehicles that have an onboard power source sufficient to propel the vehicle and others in a series of vehicles. In the case of trains traveling on railroad tracks, the locomotive is the powered vehicle. The term “track” as used here shall comprise different pathways, such as off-road, off-highway, roads, marine pathways or railroad tracks traveled by powered vehicles.

Before describing in detail the particular method and apparatus for controlling of movement or operations of a powered vehicle in accordance with the present invention, it should be observed that the present invention resides primarily in a novel combination of hardware and software elements related to said method and apparatus. Accordingly, the hardware and software elements have been represented by conventional elements in the drawings, showing only those specific details that are pertinent to the present invention, so as not to obscure the disclosure with structural details that will be readily apparent to those skilled in the art having the benefit of the description herein.

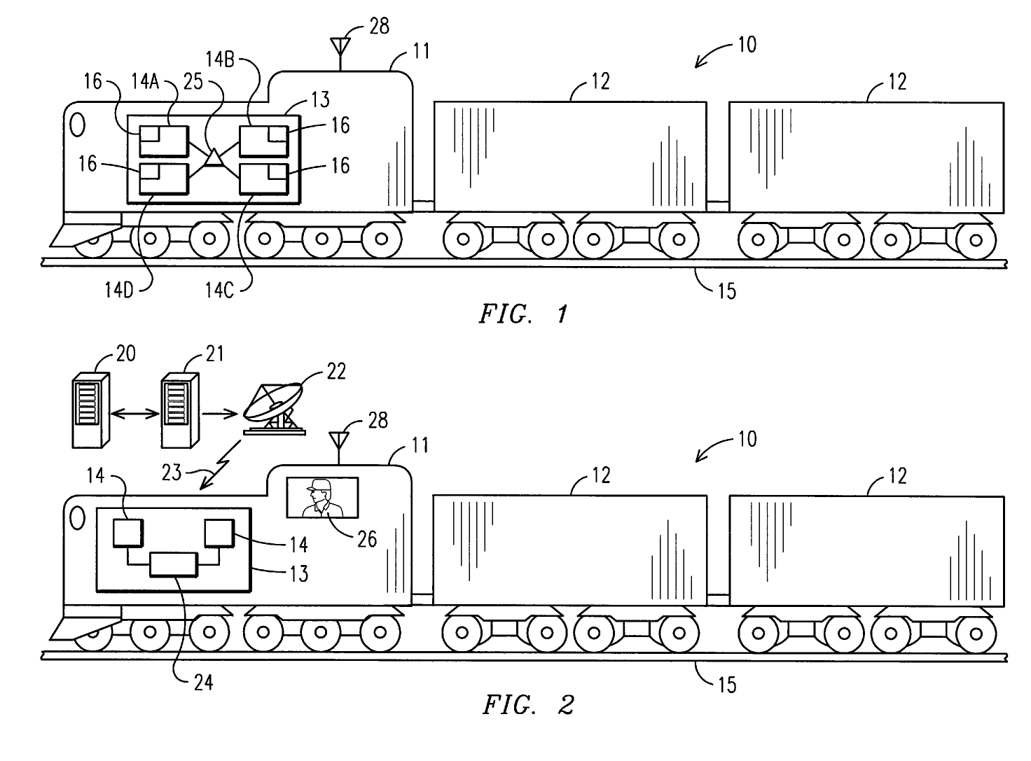

With respect to FIG. 1 there is schematically illustrated therein a train 10 including at least one locomotive 11 and a plurality of railcars 12. The locomotive 11 includes an onboard operating system 13 comprising at least two controllers that control certain locomotive functions. In the embodiment shown in FIG. 1, the operating system 13 includes four controllers 14A, 14B, 14C and 14B. By way of example, controller 14A may be a tractive controller system that generates tractive effort commands and/or braking effort commands responsive to an operator's request; controller 14B may be an operating coaching system that assists an operator in maintaining the operation of the locomotive 11 within certain predetermined limits such as a maximum tractive or braking effort, minimum or maximum acceleration/deceleration rates, speed limits, and operating sequences for bells and horns; controller 14C may be a fuel savings system that controls braking and propulsion operations to achieve fuel, emissions, and noise limits or goals; and controller 14D may be a traffic signal controller that receives and responds to off-board signals such as switching signals, light signals, cab signaling equipment, and speed restriction signals. The present invention is intended to cover an onboard operating system of a powered vehicle that includes a plurality of, or at least two controllers; and, is not limited to the embodiment shown in FIG. 1 that includes four controllers. Each of the controllers 14A through 14D may include a memory 16 in which data is stored and used by a respective controller to control certain locomotive or train operations. Such data may include, for example, data relative to a track database (wherein, as noted above, “track” refers to any designated route), a train manifest (or, more generally, a vehicle manifest), train or other vehicle operating parameters, and/or wayside traffic signal status.

More specifically, the track database may include track grade data at various points of interest along the track, track curvature data, civil speed limits and temporary speed restrictions, elevation of the track at selected locations, locations of bridges and tunnels, and the locations of wayside traffic control devices along the track. The train manifest may typically include data relative to the identification of the locomotive 11 and each of the railcars 12 in the train 10, the length and weight of the train 10, and contents of the railcars. Some railcars may contain materials (e.g., hazardous or flammable chemicals) that require special speed restrictions at selected locations along the track. So the train manifest data may also have data relative to speed restrictions. In addition, or alternatively, such speed restriction and materials data may be stored in the track database.

The data in the track database remains relatively constant with the exception of maybe the temporary speed restrictions, which may be updated as often as necessary. In an embodiment, the track profile data may be entered directly in the onboard operating system 13 and controllers 14A through 14D from a single source such as the railroad or track company. Alternatively, or in addition, one or more vendors of the controllers 14A through 14D may obtain the track profile data from a railroad or track owner and enter the data. In as much as the train manifest data may change from day to day, or from trip to trip, the train manifest data may be provided at a train dispatch center.

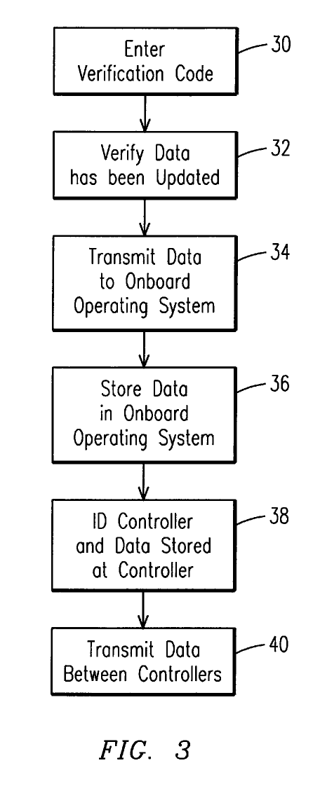

With respect to FIG. 2, there is schematically illustrated a system or method of transmitting data, such as track profile data and train manifest data, from an off-board memory to an onboard storage device. More specifically, such a system may provide for the wireless transmission or communication of data to be stored in a memory onboard the locomotive 11. The track profile data and train manifest information is typically stored on a first computer module/server 20 operated by entities that own the locomotive 11 and trains 10, or that own the track system on the which the trains 10 travel. A second server 21 is provided and linked to the first server 20 and is allowed limited access to the first server 20 in order to access the track profile data and train manifest data. The servers 20 and 21 may be linked via the Internet, local area networks, direct cable links, etc. The second server 21 may be located at the same train station as the first server 20, or remotely located elsewhere at another business cite, or could be located onboard the locomotive 11. A communication modem 22 provides for the wireless transmission, via satellite, Wi-Fi, LAN or other wireless data transmission capabilities.

The above-described data is transmitted via signal 23 to the onboard operating system 13 of the locomotive 11. A train operator 26 or other person that accesses server 20 via the second server 21 may provide an access or verification code; or, one of the servers 20, 21 is configured to provide a verification of the user to allow access to the data for transmission. (Thus, the system includes a verification access code associated with the vehicle or an operator of the vehicle to access and transmit data from an off-board memory (the server) to the onboard operating system on the vehicle.) In an embodiment shown in FIG. 2, the data transmitted may be stored in a central database 24, and each of the controllers 14 can access the database 24 to obtain the information necessary for the operation of a respective controller. With respect to the embodiment as shown in FIG. 1, the transmitted data may be stored in the respective controllers 14A through 14D. More specifically, the data may be parceled so that data used by one or more of the controllers 14A through 14D is stored in memory 16 or a data storage device for the controllers 14A-14D. For example controller 14A may utilize track grade data more frequently than the other controllers 14B-14D, so the track grade data is stored in memory 16 of controller 14A.

Data other than the track profile data and the train manifest information may be used with the disclosed system. Such data may include data that is acquired or stored during operation of the locomotive and/or data acquired while the train 10 is traveling on the track. For example, data relative to locomotive/train operating conditions (altitude, train position, ambient pressure, temperatures, dynamic braking information, horsepower, etc.), locomotive/railcar health, health of operating components on the locomotive or railcars, or wayside/signal information is stored during the operation of the locomotive 11 and 10. Data relative to the location of the locomotive 11 on the track 15 may be received via a GPS transceiver 28. This information may be stored in one or more of the controllers 14A through 14E. As discussed above, the data may be grouped and stored, or discrete data elements/pieces may be stored in a memory 16 of a respective controller 14A through 14D that uses the data the most often. For example, the data relative to health of the locomotive 11 or locomotive components may be stored in the memory 16 of a diagnostics controller.

The operating system 13 and controllers 14A through 14D may be configured to communicate or share data stored in their respective memories 16 through a local area network (LAN) system that incorporates Ethernet, Wi-Fi, or similar technologies. In an embodiment shown in FIG. 1, a communication link 25 (which may also be an integrated component of one of the controllers 14A-14D) is provided between controllers 14A and 14D which may provide a direct link between any two or more controllers for sharing data stored in the memories 16 in the respective controllers 14A and 14D. If more than two controllers 14 are used then each controller 14A-14D may be configured to know which controller contains what data. For example, a controller may be programmed to include data relative to the identity of each controller in the operating system and the type of data stored in the memory 16 of each respective controller.

In the embodiment shown in FIG. 1, the communication link 25 may include a communication router that is programmed to direct commands or requests for data from each controller to the appropriate controller memory 16 that has the requested stored data. That is, the router 25 is programmed to identify the controller 14A-14D and respective memory upon request. In this manner, the controllers 14A-14D are able to share track profile data and train manifest data, which data is the same for each controller. Moreover, the data contains the most recent updates that are shared among the controllers 14A-14D.

FIG. 3 is a flowchart illustrating the steps of a method for controlling multiple operations of a powered vehicle having an onboard operating system, according to an embodiment of the invention. In step 30, a train operator or some other authorized individual may access the station server 20 by entering a verification access code that allows the operator to access the server 20 from the locomotive 11. The operator 26 may also provide a vehicle identifier so the server 20 may access the track profile data and train manifest data associated with the locomotive 11 identifier. In step 32, the data is transmitted to the onboard operating system 13. In addition, the operator 26 may review portions of the data, such as the locomotive 11 identifier, the track sections, some of the railcar 12 identifiers, and/or a date at which the data was last updated, to verify that the train manifest data and track profile data is current. With respect to steps 34 and 36, once the operator has verified that the data is up to date, the data is transmitted from station server 20 to the onboard operating system 13. During operation of the locomotive 11, and in steps 38 and 40, controllers are able to communicate via a wireless network, by identifying a controller 14A-14D and portions of data needed to transmit the updated data between controllers 14A-14D.

Embodiments of the invention may also include a computer readable memory media for controlling operations a powered vehicle, such as a locomotive, that includes an onboard operating system comprising a plurality of controllers onboard the powered vehicle for controlling operations of the vehicle. A computer module is provided for storing data relating to the operations of the vehicle is accessible and used by at least two of the controllers for controlling vehicle operations. In addition, a computer module for transmits data between the at least two controllers to control operations of the powered vehicle. The computer readable memory media may also comprise a computer module for identifying a controller and pieces of data stored in the memory of the controller and a computer module for transmitting the pieces of data from the identified controller to requesting controller.

The computer readable memory media may be used in conjunction with the operation of a locomotive and train and includes a computer module for storing data including train manifest data or a track database. The track database includes track profile data in a data storage device off-board the locomotive and a computer module transmits at least a portion of the data to the operating system onboard the powered vehicle for storage. A computer module may be provided for entering an access verification code to access data stored in the off-board data storage device and the data is transmitted data to the operating system onboard the powered vehicle upon request. The In addition a computer module accesses manifest and track profile data associated with a locomotive 12 responsive to entry of the locomotive identifier.

Embodiments described above may be implemented on a suitable computer system, controller, data, or generally a computer readable medium. For example, the steps of the methods described above may correspond to computer instructions, logic, software code, or other computer modules disposed on the computer readable medium, e.g., floppy disc, hard drive, ASIC, remote storage, optical disc, or the like. The computer-implemented methods and/or computer code may be programmed into an electronic control unit of an engine, a main control system of the locomotive, a remote control station that communicates with the locomotive unit, or the like, as described above.

Another embodiment relates to an operating system, onboard a powered vehicle, for controlling multiple operations of the powered vehicle. In this embodiment, the operating system comprises a plurality of controllers onboard the powered vehicle for controlling multiple operations of the vehicle. The system also comprises a non-distributed memory in which data is stored. The data relates to operations and control of the powered vehicle. The system also includes a communication link between the controllers and the memory for the controllers to obtain the data from the memory and store the data in the memory (i.e., read/write operations). The non-distributed memory is the sole data storage in the powered system for long term storage of said data for the plurality of controllers. “Non-distributed” memory refers to a memory that is logically contained within a single system entity, such as a stand-alone database, computer, or memory unit. “Long term” storage refers to non-temporary or non-transitory data storage, such as in a hard disk, flash storage, or other non-volatile memory, as opposed to cache or other processor memory or local data storage that temporarily stores data for processing purposes. Thus, as should be appreciated, the non-distributed memory of this embodiment in effect comprises a sole and centralized database, accessible for data retrieval and storage by the plural controllers, for storing operations and control data in the powered vehicle for the controllers. (This embodiment does not preclude an additional stand-alone processor and associated long-term memory for the stand-alone processor; however, the non-distributed memory of the above-described embodiment is the sole long-term data storage for the plurality of controllers connected to the non-distributed memory through the communication link.)

In another embodiment, the non-distributed memory is the sole data storage in the powered vehicle for the long term storage of data for each and every controller in the powered vehicle. Thus, the powered vehicle includes a plurality of controllers, wherein the plurality of controllers comprises each and every controller in the powered vehicle, which are connected to the non-distributed memory by way of a communication link.

Another embodiment relates to an operating system, onboard a locomotive, for controlling multiple operations of the locomotive. The operating system comprises a first controller for controlling a positive train control system of the locomotive. The operating system also comprises a second controller for controlling an operator coaching and/or operator interface system of the locomotive. The operating system further comprises a third controller for controlling a trip optimizer and/or fuel savings system of the locomotive. The operating system still further comprises a memory and a communication link. Locomotive operations data is stored in the memory for each of the positive train control system, the operator coaching and/or operator interface system, and the trip optimizer and/or fuel savings system. The communication link is between the controllers and the memory, and allows the controllers to obtain the operations data from the memory and store the operations data in the memory.

In another embodiment, the memory is a non-distributed memory. Additionally, the non-distributed memory is the sole data storage in the locomotive for long term storage of the operations data for the plurality of controllers and the positive train control system, the operator coaching and/or operator interface system, and the trip optimizer and/or fuel savings system.

While various embodiments of the present invention have been shown and described herein, it will be obvious that such embodiments are provided by way of example only and not of limitation. Numerous variations, changes, and substitutions will occur to those skilled in the art without departing from the teaching of the present invention. Accordingly, it is intended that the invention be interpreted within the full spirit and scope of the appended claims.

What is claimed is:

1. An operating system, onboard a powered vehicle, for controlling multiple operations of the powered vehicle, the operating system comprising:
a plurality of controllers onboard the powered vehicle for controlling multiple operations of the vehicle, and at least one of the controllers has a memory in which data is stored and the data is accessible and used by one or more of the other controllers for controlling vehicle operations; and,
a communication link between the controllers for sharing the data stored in the memory of one of the controllers to control operations of the powered vehicle.

2. The system of claim 1, wherein the communication link is a communication router for receiving commands from one or more controllers for sharing data between controllers, and wherein the commands relate to data required for the operation of the controller and the router connects two or more controllers responsive to the commands for sharing data.

3. The system of claim 1, wherein the communication link is an integrated component of one of the controllers.

4. The system of claim 1, wherein:
the vehicle is used to control the movement of a series of vehicles in a train; the memory comprises a central database onboard the vehicle;
the data used by said one or more of the other controllers for controlling vehicle operations is stored in the database and comprises at least a portion of a track database comprising track profile data and/or train manifest data; and
the communication link provides access to the database for the controllers to retrieve the track profile data and/or train manifest data from the database.

5. The system of claim 1, wherein the powered vehicle is used to control the movement of a series of vehicles, and vehicle manifest data or a track database comprising track profile data is stored in a memory off-board the vehicle, and at least a portion of the track database or the vehicle manifest data is transmitted via wireless communication to and stored in a memory for the onboard operating system.

6. The system of claim 5, further comprising a verification access code associated with the vehicle or an operator of the vehicle to access and transmit data from the off-board memory to the onboard operating system.

7. A method for controlling multiple operations of a powered vehicle having an onboard operating system, comprising:
using a plurality of controllers onboard the powered vehicle for controlling operations of the vehicle, and at least one of the controllers has a memory in which data is stored and the data is requested and used by one of the other the controllers for controlling vehicle operations; and,
transmitting signals indicative of the requested data in the memory from one controller to another controller to control operations of the powered vehicle.

8. The method of claim 7, further comprising identifying, by a first controller, a second controller and pieces of data stored in the memory of the second controller for use by the first controller, and then transmitting the pieces of data from the identified second controller to the first controller.

9. The method of claim 7, further comprising storing data including train manifest data or a track database including track profile data in a data storage device off-board the powered vehicle, and transmitting and storing at least a portion of the train manifest data or track database to the operating system onboard the powered vehicle.

10. The method of claim 9, further comprising providing an access verification code relative to the vehicle or an operator of the vehicle to the off-board data storage device to access the data stored therein and transmit the data to the operating system onboard the powered vehicle.

11. An operating system, onboard a powered vehicle, for controlling multiple operations of the powered vehicle, the operating system comprising:
a plurality of controllers onboard the powered vehicle for controlling multiple operations of the vehicle wherein each controller controls a vehicle operation associated with that controller;
a memory, onboard the vehicle, in which data is stored and at least a portion of the data is shared by at least two of the controllers to perform the operations for those controllers; and,
a communication link between the memory and the at least two controllers for accessing the memory and transmitting signals associated with the shared data from the memory to the at least two controllers.

12. The operating system of claim 11, wherein the memory is a component of one or more of the controllers.

13. The operating system of claim 11, wherein the memory includes data storage devices as components of at least said at least two of the controllers, and one or more of the plurality of controllers is a requesting controller configured to transmit a signal over the communication link that is indicative of an identity of a controller and data stored in memory of the identified controller to be shared with and used by the requesting controller for controlling vehicle operations.

14. An operating system, onboard a powered vehicle, for controlling multiple operations of the powered vehicle, the operating system comprising:
a plurality of controllers onboard the powered vehicle for controlling multiple operations of the vehicle;
a non-distributed memory in which data is stored, said data relating to operations and control of the powered vehicle; and
a communication link between the controllers and the memory for the controllers to obtain the data from the memory and store the data in the memory;
wherein the non-distributed memory is the sole data storage in the powered system for long term storage of said data for the plurality of controllers.

15. An operating system, onboard a locomotive, for controlling multiple operations of the locomotive, the operating system comprising:
a first controller for controlling a positive train control system of the locomotive;
a second controller for controlling an operator coaching and/or operator interface system of the locomotive;
a third controller for controlling a trip optimizer and/or fuel savings system of the locomotive;
a memory in which locomotive operations data is stored for each of the positive train control system, the operator coaching and/or operator interface system, and the trip optimizer and/or fuel savings system; and
a communication link between the controllers and the memory for the controllers to obtain the operations data from the memory and store the operations data in the memory.

16. The operating system of claim 15, wherein:
the memory is a non-distributed memory; and
the non-distributed memory is the sole data storage in the locomotive for long term storage of said operations data for the plurality of controllers and the positive train control system, the operator coaching and/or operator interface system, and the trip optimizer and/or fuel savings system.
